(19) United States
(12) Patent Application Publication
(10) Pub. No.: US 2025/0380225 A1
(43) Pub. Date: Dec. 11, 2025

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Haruhi ECHIGO, Tokyo (JP); Satoshi NAGATA, Tokyo (JP); Qiping PI, Beijing (CN)

(73) Assignee: NTT DOCOMO, INC., Tokyo (JP)

(21) Appl. No.: 18/876,225

(22) PCT Filed: Jun. 22, 2022
(86) PCT No.: PCT/JP2022/024828

§ 371 Date: Dec. 18, 2024

(51) Int. Cl. H04W 52/36; H04W 52/14

(52) U.S. Cl. CPC H04W 52/367; H04W 52/146; H04W 52/365

(57) ABSTRACT

A terminal according to one aspect of the present disclosure includes a transmitting section that transmits a report including one or more pieces of state information regarding utilization of higher output power than nominal maximum output power corresponding to a band, and a control section that controls uplink transmission using the output power when the state information indicates that the utilization is possible. According to one aspect of the present disclosure, the coverage of UL transmission can be improved.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study,

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Improvements in coverage are under consideration for future radio communication systems (for example, NR).

However, uplink (UL) transmission using higher transmission power than the nominal maximum output power is unclear. If UL transmission using higher transmission power is not sufficiently considered, there may occur reduced coverage, deteriorated communication quality, lowered throughput, and the like.

In view of this, one of the objects of the present disclosure is to provide a terminal, a radio communication method, and a base station that improve the coverage of UL transmission.

A terminal according to one aspect of the present disclosure includes a transmitting section that transmits a report including one or more pieces of state information regarding utilization of higher output power than nominal maximum output power corresponding to a band, and a control section that controls uplink transmission using the output power when the state information indicates that the utilization is possible.

### Advantageous Effects of Invention

According to one aspect of the present disclosure, the coverage of UL transmission can be improved.

### BRIEF DESCRIPTION OF DRAWINGS

FIG. 1 shows an example of the relationship between UE power classes and nominal maximum output power.

FIG. 2 shows an example of a limitation on NR transmission power in EN-DC.

FIGS. 3A and 3B show examples of total maximum output power.

FIG. 4 shows an example of a single-entry PHR MAC CE in Rel-15/16 NR.

FIG. 5 shows an example of a multiple-entry PHR MAC CE in Rel-15/16 NR.

FIG. 6 shows an example of mapping between PH values and measured quantity values.

FIG. 7 shows an example of mapping between P_CMAX values and measured quantity values.

FIG. 8 shows an example of mapping between reported values and measured quantity values of FR2 P-MPR.

FIG. 9 shows an example of simultaneous transmission in a plurality of cells of CA/DC.

FIG. 10 shows an example of reporting of state information.

FIG. 11 shows an example of reporting and simultaneous transmission in the plurality of cells.

FIG. 12 shows an example of a single-entry PHR MAC CE according to reporting method 3.

FIG. 13 shows an example of a multiple-entry PHR MAC CE according to reporting method 3.

FIG. 14 shows another example of a multiple-entry PHR MAC CE according to reporting method 3.

FIG. 15 shows an example of an extended single-entry PHR MAC CE according to reporting method 3.

FIG. 16 shows another example of an extended single-entry PHR MAC CE according to reporting method 3.

FIG. 17 is a diagram to show an example of a schematic configuration of a radio communication system according to an embodiment.

FIG. 18 is a diagram to show an example of a configuration of a base station according to an embodiment.

FIG. 19 is a diagram to show an example of a configuration of a user terminal according to an embodiment.

FIG. 20 is a diagram to show an example of a hardware configuration of the base station and the user terminal according to an embodiment.

FIG. 21 is a diagram to show an example of a vehicle according to an embodiment.

### DESCRIPTION OF EMBODIMENTS

### PUSCH Transmission Power Control

In NR, the transmission power of a PUSCH is controlled based on a TPC command (also called value, increase/decrease value, correction value, or the like) indicated by the value of a field in a DCI (also called TPC command field or the like).

For example, when a UE transmits a PUSCH on an active UL BWP b of a carrier f of a serving cell c using a parameter set (open loop parameter set) having an index j and a power control adjustment state (PUSCH power control adjustment state) having an index l, the transmission power of the PUSCH (P_{PUSCH,b,f,c}(i, j, q_{d}, l)) [dBm] in a PUSCH transmission occasion (also called transmission period or the like) i may be based on at least one of P_{CMAX,f,c(i)}, P_{O-PUSCH,b,f,c}(j), M^{PUSCH}_{RB,b,f,c}(i), σ_{b,f,c}(j), PL_{b,f,c}(q_{d}), Δ_{TF,b,f,c}(i), f_{b,f,c}(i,l) as expressed by the following equation.

$$\begin{matrix}[ Math . 1 ] & \\ {P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] & ( 1 )\end{matrix}$$

The power control adjustment state may be referred to as a closed loop (CL)-power control (PC) state, a TPC command-based value of a power control adjustment state index l, an accumulated value of TPC commands, or a closed loop-based value, where l may be referred to as a closed loop index.

The PUSCH transmission occasion i is a period during which the PUSCH is transmitted, and may be constituted of one or more symbols, one or more slots, or the like, for example.

P_{CMAX,f,c}(i) is the maximum transmission power (configured maximum output power, UE configured maximum output power) of a user terminal configured for the carrier f of the serving cell c at the transmission occasion i, for example.

P_{O-PUSCH,b,f,c}(j) is a parameter related to a target received power configured for the active UL BWP b of the carrier f of the serving cell c at the transmission occasion i (for example, also referred to as a parameter related to a transmission power offset, a transmission power offset P0, a target received power parameter, or the like), for example. P_{O_UE_PUSCH,b,f,c}(j) may be the sum of P_{O_NOMINAL_PUSCH,f,c}(j) and P_{O_UE_PUSCH,b,f,c}(j).

M^{PUSCH}_{RB,b,f,c}(j) is the number of resource blocks (bandwidth) allocated to the PUSCH for the transmission occasion i in the active UL BWP b of the serving cell c and carrier f with subcarrier spacing μ, for example. σ_{b,f,c}(j) takes a value provided by higher layer parameters (for example, also referred to as msg3-Alpha, p0-PUSCH-Alpha, fractional factor, or the like).

PL_{b,f,c}(q_{d}) is a path loss (path loss estimation [dB], path loss compensation) calculated in the user terminal using an index q_{d} of a reference signal (RS), pathloss reference RS, pathloss (PL)-RS, pathloss reference RS, path loss measurement DL-RS, PUSCH-PathlossReferenceRS) for a downlink BWP associated with the active UL BWP b of the carrier f of the serving cell c, for example.

If the UE is not provided with a pathloss reference RS (for example, PUSCH-PathlossReferenceRS) or if the UE is not provided with individual higher layer parameters, the UE may calculate PL_{b,f,c}(q_{d}) using RS resources from a synchronization signal (SS)/physical broadcast channel (PBCH) block (SS block (SSB)) used to obtain a Master Information Block (MIB).

If the UE is configured with a number of RS resource indices up to a value of a maximum number of pathloss reference RSs (for example, maxNrofPUSCH-PathlossReferenceRSs) and a set of respective RS configurations for the RS resource indices by the pathloss reference RSs, the set of RS resource indices may include one or both of a set of SS/PBCH block indices and a set of channel state information (CSI)-reference signal (RS) resource indices. The UE may identify the RS resource index q_{d} in the set of RS resource indices.

If PUSCH transmission is scheduled by a Random Access Response (RAR) UL grant, the UE may use the same RS resource index ga as that for the corresponding PRACH transmission.

If the UE is provided with a power control configuration for the PUSCH via a sounding reference signal (SRS) resource indicator (SRI) (for example, SRI-PUSCH-PowerControl) and one or more values of ID of the pathloss reference RS, the UE may obtain mapping between a set of values for the SRI field in DCI format 0_1 and a set of ID values of the pathloss reference RS from higher layer signaling (for example, SRI-PUSCH-PowerControl-Id in SRI-PUSCH-PowerControl). The UE may determine the RS resource index q_{d} from the ID of the pathloss reference RS mapped to the SRI field value in DCI format 0_1 that schedules the PUSCH.

If a PUSCH transmission is scheduled by DCI format 0_0 and the UE is not provided with PUCCH spatial relation information for a PUCCH resource with the lowest index for the active UL BWP b of each carrier f and serving cell c, the UE may use the same RS resource index q_{d} as that for a PUCCH transmission in the PUCCH resource.

If a PUSCH transmission is scheduled by DCI format 0_0 and the UE is not provided with spatial settings for a PUCCH transmission, or if a PUSCH transmission is scheduled by DCI format 0_1 that does not include an SRI field, or if the UE is not provided with configurations for PUSCH power control by the SRI, the UE may use the RS resource index q_{d} with a pathloss reference RS ID of zero.

For a PUSH transmission configured by a configured grant configuration (for example, ConfiguredGrantConfig), if the configured grant configuration includes a specific parameter (for example, rrc-ConfiguredUplinkGrant), the RS resource index q_{d} may be provided to the UE by a path loss reference index (for example, pathlossReferenceIndex) in the specific parameter.

For a PUSCH transmission configured by the configurated grant configuration, if the configuration grant configuration does not include a specific parameter, the UE may determine the RS resource index q_{d} from the value of the ID of the pathloss reference RS mapped to the SRI field in the DCI format that activates the PUSCH transmission. If the DCI format does not include the SRI field, the UE may determine the RS resource index q_{d} with a pathloss reference RS ID of zero.

Δ_{TF,b,f,c}(i) is the transmission power adjustment component (offset, transmission format compensation) for the UL BWP b of the carrier f of the serving cell c.

f_{b,f,c}(i, l) is the PUSCH power control adjustment state for the active UL BWP b of the carrier f of the serving cell c at the transmission occasion i. f_{b,f,c}(i, l) may be based on δ_{PUSCH,b,f,c}(i, l).

If TPC accumulation is enabled, f_{b,f,c}(i, l) may be based on the accumulated value of δ_{PUSCH,b,f,c}(m, l).

If TPC accumulation is disabled, f_{b,f,c}(i, l) may be δ_{PUSCH,b,f,c}(i, l) (absolute value).

If information indicating that TPC accumulation is disabled (TPC-Accumulation) is not configured (if information indicating that TPC accumulation is disabled is not provided, or if TPC accumulation is configured to be enabled), the UE accumulates the TPC command values and determines the transmission power based on the accumulation result (power control state) (applies the TPC command values via accumulation).

If information indicating that TPC accumulation is disabled (TPC-Accumulation) is configured (if information indicating that TPC accumulation is disabled is provided, or if TPC accumulation is configured to be disabled), the UE determines the transmission power based on the TPC command values (power control state) without accumulating the TPC command values (applies the TPC command values without accumulation).

δ_{PUSCH,b,f,c}(i, l) may be the TPC command value included in DCI format 0_0 or DCI format 0_1 that schedules the PUSCH transmission occasion i on the active UL BWP b of the carrier f of the serving cell c, or the TPC command value jointly coded with other TPC commands in DCI format 2_2 with a CRC scrambled by a specific RNTI (Radio Network Temporary Identifier) (for example, TPC-PUSCH-RNTI).

Σₘ₌₀^{C(Di)-}δ_{PUCCH,b,f,c}(m, 1) may be the sum of TPC command values in a set Dᵢ of TPC command values with a cardinality C(Dᵢ). Dᵢ may be a set of TPC command values that the UE receives between before a K_{PUSCH}(i-i₀)-1 symbol at a PUSCH transmission occasion i-i₀ and before a K_{PUSCH}(i) symbol at the PUSCH transmission occasion i on the active UL BWP b of the carrier f of the serving cell c for a PUSCH power control adjustment state l. i₀ may be the smallest positive integer with which before the K_{PUSCH}(i-i₀) symbol at the

PUSCH transmission occasion i-i₀ is earlier than before the K_{PUSCH}(i) symbol at the PUSCH transmission occasion i.

If a PUSCH transmission is scheduled by DCI format 0_0 or DCI format 0_1, K_{PUSCH}(i) may be the number of symbols in the active UL BWP b of the carrier f of the serving cell c after the last symbol of the corresponding PDCCH reception and before the first symbol of the PUSCH transmission. If a PUSCH transmission is configured by configured grant configuration information (ConfiguredGrantConfig), K_{PUSCH}(i) may be the number of K_{PUSCH,min} symbols in the active UL BWP b of the carrier f of the serving cell c, which is equal to the product of the number of symbols per slot N_{symb}^{slot} and the minimum value provided by k2 in PUSCH common configuration information (PUSCH-ConfigCommon).

The power control adjustment state may be configured to have a plurality of states (for example, two states) or a single state by a higher layer parameter. If a plurality of power control adjustment states are configured, one of the plurality of power control adjustment states may be identified by an index l (for example, l∈{0,1}).

The transmission power of the PUCCH and the transmission power of the SRS are both limited by the configured maximum output power P_{CMAX,f,c}(i) in the same manner as the transmission power of the PUSCH.

### Nominal Maximum Output Power/Configured Maximum Output Power

The UE power class defines the maximum output power (nominal maximum output power, nominal UE power, UE maximum output power) for a transmission bandwidth within the channel bandwidth of an NR carrier.

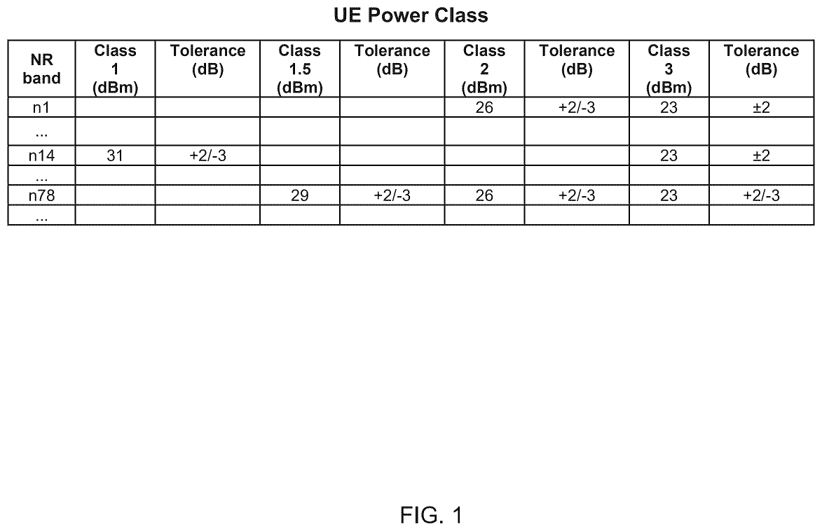

As in the example of FIG. 1, nominal maximum output power P_PowerClass is defined per UE power class (power class) and band. Power class 1 is defined for public safety only. Power class 1.5 is defined for UEs with dual transmission (Tx). Power class 2 is defined for high power UEs. Power class 3 is defined for handheld cellular UEs.

Class 3 with 23 dBm is the default power class, and 23 dBm is derived on the assumption of the specific absorption rate (SAR) when 100% of a resource is used for UL transmission.

The settings (upper and lower limits) of P_CMAX are defined by the following expression.

$$\begin{matrix}[ Math . 2 ] & \\ {P}_{CMAX \_ L , f , c} \leq {P}_{CMAX , f , c} \leq {P}_{CMAX \_ H , f , c} with \\ {P}_{CMAX \_ L , f , c} = MIN \{ {P}_{EMAX , c} - Δ {T}_{C , c} , \\ ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \\ {P}_{CMAX \_ H , f , c} = MIN \{ {P}_{EMAX , c} , {P}_{PowerClass} - Δ {P}_{PowerClass} \} & ( 2 )\end{matrix}$$

In Expression 2, P_EMAX,c has the value given by a p-Max information element or additionalPmax for the serving cell c (maximum permissible UE output power notified by a higher layer), and ΔP_PowerClass denotes the adjustment to the nominal maximum output power P_PowerClass for a given power class, which is a duty cycle-dependent power constraint.

In any of the following states (conditions) 1 to 4, P_PowerClass>0. In any state other than the states 1 to 4, P_ PowerClass=0.

### [State 1]

If any of the following conditions are met, P_PowerClass=3 dB for power class (PC) 2 UEs and ΔP_PowerClass=6 dB for PC1.5 UEs:
p-Max of 23 dBm or less is specified.
No field of UE capability maxUplinkDutyCycle-PC2-FR1 field is present, no field of UE capability maxUplinkDutyCycle-MPE-FR1 is not present, and the percentage of UL symbols transmitted within a certain evaluation period is higher than 50%.
The field of UE capability maxUplinkDutyCycle-PC2-FR1 is present, and the percentage of UL symbols transmitted in a certain evaluation period is higher than that of maxUplinkDutyCycle-PC2-FR1 (the exact evaluation period is shorter than one radio frame).
The field of UE capability maxUplinkDutyCycle-MPE-FR1 is present, and the percentage of UL symbols transmitted in a certain evaluation period is higher than that of maxUplinkDutyCycle-MPE-FR1 (the exact evaluation period is shorter than one radio frame).

### [State 2]

If any of the following conditions are met, P_PowerClass=3 dB for PC1.5 UEs:
p-Max between 23 dBm and 26 dBm is specified.
No field of UE capability maxUplinkDutyCycle-PC2-FR1 is present, no field of UE capability maxUplinkDutyCycle-MPE-FR1 is present, and the percentage of UL symbols transmitted within a certain evaluation period is between 25% and 50%.
The field of UE capability maxUplinkDutyCycle-PC2-FR1 is present, and the percentage of UL symbols transmitted in a certain evaluation period is between that of maxUplinkDutyCycle-PC2-FR1 and that of maxUplinkDutyCycle-PC2-FR1/2 (the exact evaluation period is shorter than one radio frame).
The field of UE capability maxUplinkDutyCycle-MPE-FR1 is present, and the percentage of UL symbols transmitted in a certain evaluation period is higher than that of maxUplinkDutyCycle-MPE-FR1 (the exact evaluation period is shorter than one radio frame).

### [State 3]

If the UE is configured with a supplemental uplink (SUL) configuration and in the band in which the UE exhibits power class 2, the default power class requirements defined in the specification apply, then ΔP_PowerClass=3 dB.

### [State 4]

If a PC2-capable UE with transmit diversity (txDiversity-r16) capability or a PC1.5-capable UE indicates SRS transmission switch (SRS-TXSwitch) capability ‘t1r2’ or ‘t1r4’ or ‘t1r1-t1r2’ or ‘t1r1-t1r2-t1r4’, ΔP_PowerClass=3 dB is applied during an SRS transmission occasion with SRS resources configured in each SRS resource set constituted of one SRS port and with usage in SRS-ResourceSet set to antenna switching ('antennaSwitching').

Rel-17 NR defines a high power UE, which can perform transmission using power higher than 23 dBm. 23 dBm is considered as the default PC (PC3). 23 dBm is derived based on SAR requirements for the UE to transmit a UL on 100% of a resource,

### Upper Limit of Transmission Power in CA and DC

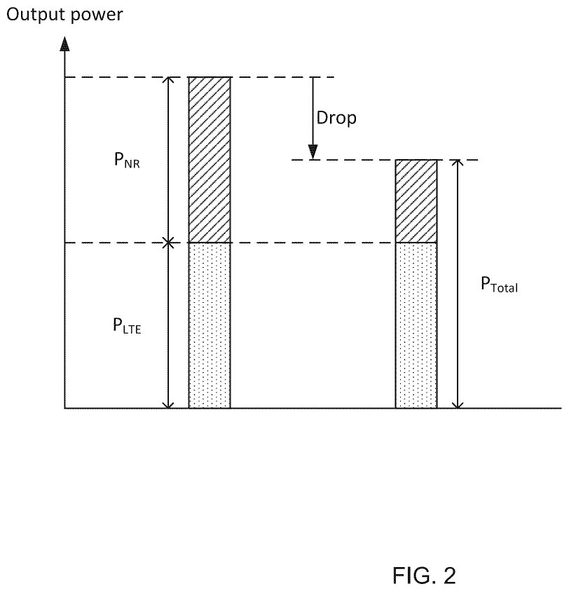

A UE with a dynamic power sharing capability can be configured with total maximum transmission power P_Total∧EN-DC (P_Total) in EN-DC. The total maximum transmission power is based on a configured value P_EMAX, EN-DC (p-maxUE-FR1) and a power class-based value P_PowerClass, EN-DC-ΔP_PowerClass, EN-DC. As in the example of FIG. 2, if the sum of an NR transmission power P_NR and E-UTRA transmission power P_LTE exceeds the total maximum transmission power P_Total, the NR transmission power is limited until the sum becomes equal to or less than P_Total.

Increasing the upper limits of the UE power for carrier aggregation (CA) and dual connectivity (DC) is under consideration.

For example, in an inter-band CA, extending P_CMAX for the entire CA transmission to utilize all the available nominal maximum output power according to UE capabilities (for example, HigherPowerLimitCADC) is under consideration. That is, P_PowerClass is replaced by 10log10ΣP_PowerClass,c, where P_PowerClass,c is the P_PowerClass of each band.

For example, in an inter-band E-UTRAN/NR(EN)-DC, extending P_CMAX for the entire CA transmission to utilize all the available nominal maximum output power according to the UE capabilities (for example, HigherPowerLimitCADC) is under consideration. That is, P_ PowerClass is replaced by a value obtained by converting the sum of the linear values of P_PowerClass,NR and P_PowerClass,E-UTRA to dB, where P_PowerClass, NR is the P_PowerClass of NR, and P_PowerClass, E-UTRA is the P_PowerClass of E-UTRA,

In the present disclosure, utilizing all the available nominal maximum output power may be referred to as high power CA/DC UL transmission.

For this function, the following items are under consideration:
The amount of UL resources during the evaluation period.
Whether a supplemental uplink (SUL) is configured.
Whether the UL transmission is an SRS with antenna switching.

To enable high power CA/DC UL transmissions, it is preferable that ΔP_PowerClass=0 as described above.

It is here assumed that the maximum output power of CC #1 (band #1) is 26 dBm, and the maximum output power of CC #2 (band #2) is 23 dBm.

If an individual power amplifier (PA) is implemented for each CC/band, the total maximum output power technically possible is 27.76 dBm, assuming full power for each CC.

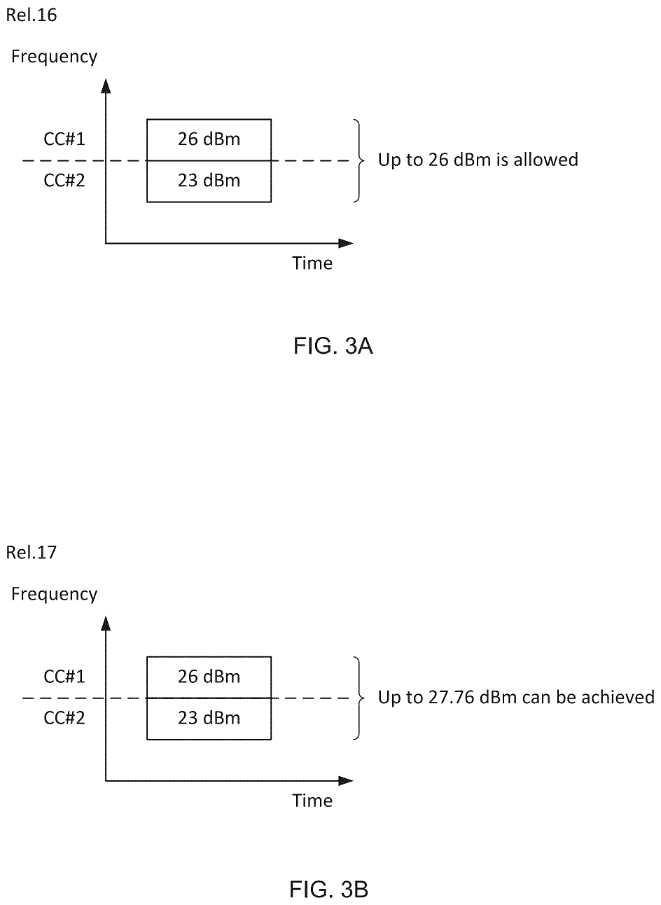

Prior to Rel.16, if the CA/DC power class is PC3, the total maximum output power is 23 dBm, and if the CA/DC power class is PC2, the total maximum output power is 26 dBm. As shown in the example of FIG. 3A, total maximum output power higher than 26 dBm is not allowed.

In Rel.17, if the CA/DC power class is PC3, the total maximum output power is 23 dBm, and if the CA/DC power class is PC2, the total maximum output power is 26 dBm. As shown in the example of FIG. 3B, if the CA/DC power class is PC2 and the UE reports a capability (HigherPowerLimitCADC), the total maximum output power is 27.76 dBm.

### PHR

As power headroom reporting (PHR), any of types 1 to 3 and Maximum Permissible Exposure (MPE) Power Management Maximum Power Reduction (P-MPR) reporting can be used. Type 1 provides a serving gNB with the difference between the nominal maximum output power and the power estimated for UL-SCH transmission, for each activated serving cell. Type 2 provides the serving qNB with the difference between the nominal maximum output power and the power estimated for UL-SCH and PUCCH transmissions on the SpCell of another MAC entity. Type 3 provides the serving qNB with the difference between the nominal maximum output power and the power estimated for SRS transmission, for each activated serving cell. The MPE P-MPR provides the serving gNB with a power backoff to meet the MPE FR2 requirements for serving cells operating on an FR2.

The PHR is triggered based on at least one of the following: expiration of a PHR prohibition timer (phr-ProhibitTimer), a change in path loss (threshold phr-Tx-PowerFactorChange), expiration of a PHR periodic timer (phr-PeriodicTimer), activation of an SCell, activation of an SCG, addition of a PSCell, the MAC entity having UL resources for transmission, a change in the required power backoff (threshold phr-Tx-PowerFactorChange), switching of the BWP of the SCell, configuration of MPE FR2 reporting (mpe-Reporting-FR2), and measured P-MPR (threshold phr-Tx-PowerFactorChange).

If multiplePHR is configured, a multiple-entry PHR is used, and if not, a single-entry PHR is configured.

The PHR may be transmitted by MAC (Medium Access Control) signaling using a PUSCH (Physical Uplink Shared Channel). For example, the PHR is notified by using a PHR MAC CE (Control Element) included in a MAC PDU (Protocol Data Unit).

In the NR, a single-entry PHR MAC CE for a primary cell (PCell) is supported.

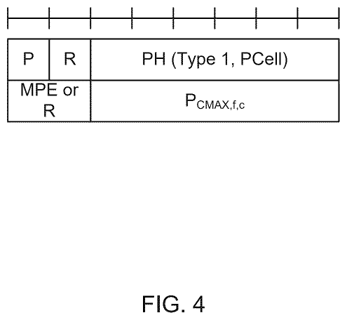

FIG. 4 shows an example of a single-entry PHR MAC CE in Rel-15/16 NR. The MAC CE is constituted of 2 octets (=16 bits). This MAC CE includes fields R, PH, P, P_CMAX, f, c, and MPE,

Each ‘R’ indicates a 1-bit reserved field, which is set to a value of ‘0’, for example.

‘PH (Type 1, PCell)’ indicates a 6-bit field that representing an index for a type 1 PH of a primary cell (PCell). The index for the PH is associated with a specific PH value (in decibels (dB)) (or level).

Note that, for example, Type 1 PH may be a PH taking into consideration the PUSCH (for example, taking into consideration only the power of the PUSCH), Type 2 PH may be a PH taking into consideration the PUCCH (for example, taking into consideration the power of both the PUSCH and the PUCCH), and Type 3 PH may be a PH taking into consideration a measurement reference signal (Sounding Reference Signal (SRS)) (for example, taking into consideration the power of the PUSCH and the SRS).

‘P_{CMAX,f,c}’ indicates a 6-bit field, and represents an index for P_{CMAX,f,c} used in the calculation of the PH field. The index for P_{CMAX,f,c} is associated with a specific UE transmission power level (dB). Note that P_{CMAX,f,c} may also be referred to as configured maximum transmission power (maximum permitted transmission power) for the serving cell c of the carrier f. Hereinafter, P_{CMAX,f,c} may be simply expressed as P_{CMAX}, PCMAX, or the like.

‘P’ may be a field related to Power Management Maximum Power Reduction (P-MPR) or Maximum Permitted UE Output Power Reduction, or may be a filed related to Maximum Permitted Exposure (MPE). The ‘MPE’ field may be a field related to MPE. The fields ‘P’, ‘MPE’, and the like may be replaced with the ‘R’ field, depending on the configuration using higher layer signaling to the UE.

The ‘P’ field is configured with MPE reporting for FR2 (higher layer parameter mpe-Reporting-FR2). When the serving cell operates in the FR2, the ‘P’ field is configured as 0 if the P-MPR value applied to satisfy the MPE requirements is less than a specific P-MPR value (for example, P-MPR_00), and the ‘P’ field is configured as 1 if not.

The ‘P’ field may also indicate whether a power backoff is applied to power management if MPE reporting for FR2 is not configured or the serving cell is operating in the FR1. Note that the ‘P’ field is configured to 1 if the corresponding P_{CMAX} field would have a different value unless a power backoff is applied to power management.

The ‘MPE’ field may indicate the power backoff to be applied to satisfy the MPE requirements if MPE reporting for FR2 (higher layer parameter mpe-Reporting-FR2) is configured, the serving cell is operating in the FR2, and the ‘P’ field is configured to 1. This field may indicate an index corresponding to the measured P-MPR value (for example, in dB).

If the MPE reporting for FR2 is not configured, or if the serving cell is operating in the FR1, or if the ‘P’ field is configured to 0, the R field (R bits) may be present instead of the ‘MPE’ field,

In the NR, a multiple-entry PHR MAC CE that includes a plurality of pieces of data similar to the above-described single-entry (2 octets) is also supported. The multiple-entry PHR MAC CE may include a PH field for Primary Secondary Cell (PSCell) and Secondary Cell (SCell). Note that the PCell and the PSCell may also be called special cells (SpCell).

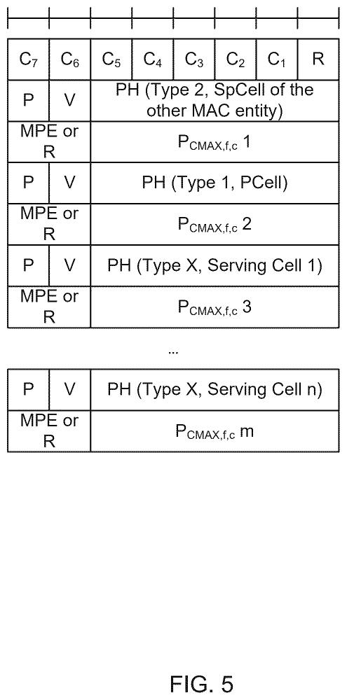

FIG. 5 shows an example of a multiple-entry PHR MAC CE in the Rel-15/16 NR. This MAC CE includes fields C_i, R, V, PH, P, P_CMAX, f, c, and MPE. The same fields as those in the single-entry PHR MAC CE will not be described again.

The 6-bit field ‘PH’ indicates the corresponding type (for example, Types 1 to 3 described above) and PH field for the cell.

Note that the presence of the Type 2 PH field for the SpCell of another MAC entity may be configured by the higher layer parameter phr-Type2OtherCell being true.

The 6-bit field ‘_{CMAX,f,c}’ indicates the P_{CMAX,f,c} used in the calculation of the previous PH field. The ‘Ci’ field indicates whether the PH field of the serving cell corresponding to the serving cell index i is included in the PHR. Note that the drawing indicates the example in which the maximum serving cell index is smaller than 8. If the maximum serving cell index indicates 8 or more, the MAC CE may include a ‘Cᵢ’ field that can indicate serving cells up to i=31, for example.

Note that the number assigned to “serving cell” in the PH field and the number assigned to the P_{CMAX,f,c} field do not have to mean the serving cell index, and may simply mean the ordinal values included in the MAC CE.

The ‘V’ field indicates whether the PH value corresponding to the immediately following PH field is based on real transmission (V=0) or based on a reference format (V=1). The PH based on a reference format may be called virtual PH. Note that when V=1, the corresponding ‘P_{CMAX,c}’ field, ‘MPE’ field, and the like may be omitted.

The network may transmit, to the UE, PHR configuration information as to the conditions for triggering the PHR. The PHR configuration information may be a prohibit timer, a periodic timer, a path loss change threshold, and the like, The notification may be performed using higher layer signaling. The UE triggers the PHR if the PHR trigger conditions are met.

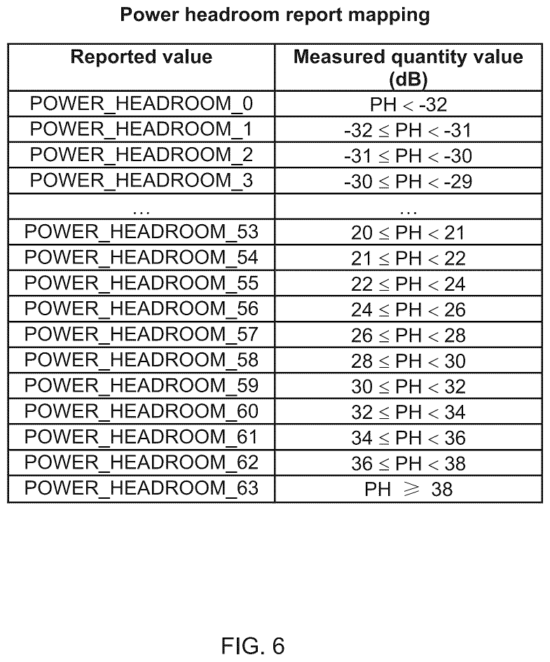

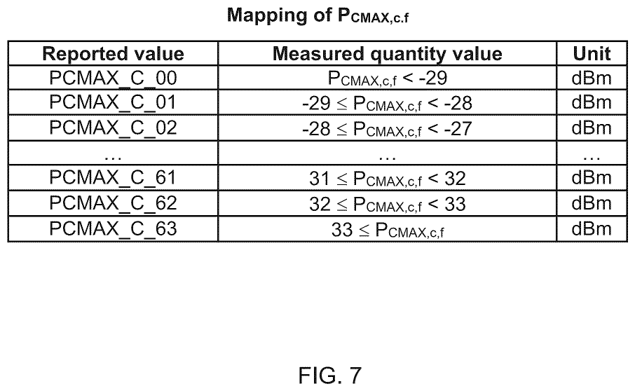

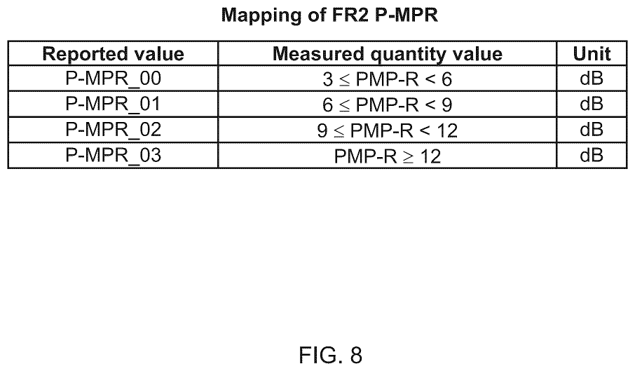

As in the example of FIG. 6, the specification defines a mapping between PH values and measured quantity values (ranges). As in the example of FIG. 7, the specification defines a mapping between P_CMAX values and measured quantity values (ranges). As in the example of FIG. 8, the specification defines a mapping between reported values and measured quantity values (ranges) of FR2 P-MPR.

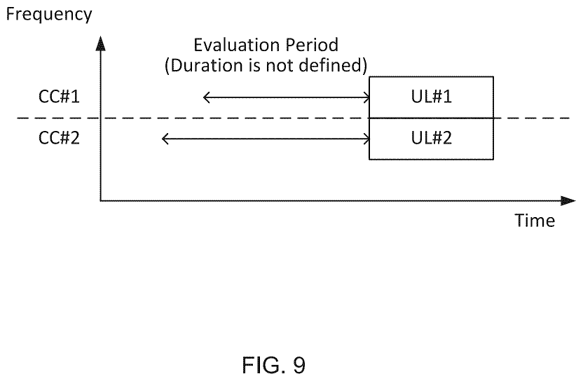

If the UE reports the capability of high power CA/DC UL transmission and meets the required conditions, inter-UL band CA/DC is practical. If the UE does not report the capability of high power limitation of CA/DC, the transmission power in each CC is limited, so that inter-UL band CA/DC is not practical, causing coverage limitation. From the base station's point of view, it is not clear whether the UE actually meets the conditions. As in the example of FIG. 9, when the UE uses CA/DC to perform simultaneous transmission in CC #1 and CC #2, it is not clear to the network (NW)/gNB whether the UE uses high power CA/DC UL transmission.

In this way, the operation of UL transmission using higher transmission power than the nominal maximum output power corresponding to the band/power class (high-power UL transmission) is unclear. If high-power UL transmission is not sufficiently considered, it may lead to a reduction in coverage, a deterioration in communication quality, a decrease in throughput, and the like.

Therefore, the inventors of the present invention came up with a method for determining transmission power.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, nominal maximum output power, nominal UE power, UE maximum output power, maximum UE power, maximum output power, maximum output power defined for a power class, P_PowerClass, P_{PowerClass} may be read interchangeably, In the present disclosure, adjustment to the maximum output power for a given power class, adjustment to the nominal maximum output power, ΔP_PowerClass, ΔP_{PowerClass} may be read interchangeably.

In the present disclosure, configured maximum output power, configured transmission power, UE configured maximum output power, configured maximum UE output power, actual maximum output power, maximum output power, P_CMAX, P_{CMAX,f,c}(i) may be read interchangeably. In the present disclosure, UE power class, power class, PC may be read interchangeably.

In the present disclosure, base station, qNB, and network (NW) may be read interchangeably.

### Radio Communication Method

In each embodiment, the uplink (UL) transmission may include at least one of a PUSCH, a PUCCH, and an SRS.

In each embodiment, the upper limit of transmission power (PUSCH transmission power, PUCCH transmission power, SRS transmission power), the configured maximum output power P_{CMAX,f,c}(i), the upper limit of the configured maximum output power P_{CMax_H,f,c}, and P_{PowerClass} ΔP_{PowerClass} may be read interchangeably.

In each embodiment, the high power UL transmission may include a high power CA/DC UL transmission, or may include a UL transmission that uses higher power than the existing nominal maximum output power corresponding to the power class and band in a single cell/CC.

The CA/DC operation in each embodiment may be applied if at least one of the following operating conditions is met:
[Operation condition 1] The UE is configured to operate in a single UL carrier/band/CC.
[Operation condition 2] The UE is configured to operate in a plurality of UL carriers/bands/CCs.

The CA/DC operation may be an inter-band CA/DC operation, a non-contiguous intra-band CA/DC operation, or a contiguous intra-band CA/DC operation.

Each embodiment may be applied to UL CA/DC operations only.

The UE may transmit a report including one or more pieces of state information regarding the use of output power (for example, total maximum output power) higher than the nominal maximum output power corresponding to the band/power class (high power UL transmission). If the state information indicates the availability of the output power, the UE may control the UL transmission using the output power.

If the UE performs UL transmission in one or more cells, the condition for high power UL transmission may be that ΔP_PowerClass in all of the one or more cells is zero at that time. If the UE performs simultaneous UL transmission in plurality of cells using CA/DC, the condition for high power CA/DC UL transmission may be that ΔP_PowerClass in all of the plurality of cells is zero at that time.

### <Embodiment #1>

Reporting information as to whether the UE meets the conditions for using higher power (state information) may be introduced. This allows the base station to recognize whether high power UL transmission is available for one or more bands.

### <<Embodiment #1-1>>

The state information may include at least one of the following:
Whether ΔP_PowerClass is zero or not.
Whether high power UL transmission (high power CA/DC UL transmission) is possible (whether the conditions for high power UL transmission are met).
After how much time high power UL transmission (high power CA/DC UL transmission) will become possible (after how much time the conditions for high power UL transmission will be met). The time may be expressed in units of radio frames (10 ms)/slots/symbols or in absolute time (for example, ms/μs).
The duration of the evaluation period, which may be expressed in units of radio frames (10 ms)/slots/symbols or in absolute time (for example, ms/μs).

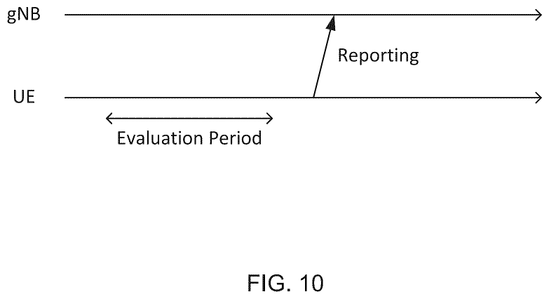

As in the example of FIG. 10, the UE may report the state information after the evaluation period.

In the base station, the state information may be used to determine whether to configure a coverage compensation scheme, and may be used to determine whether to configure a UL CA/DC operation using the band. For example, the coverage compensation scheme may be repetition.

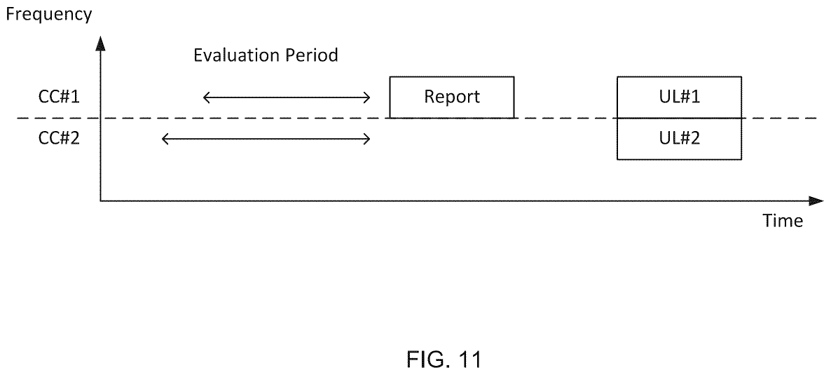

As in the example of FIG. 11, in the UL CA/DC operation, the evaluation period may be different for each UE or may be different for each CC. The UE may report state information after the evaluation period and then may transmit UL #1 and UL #2 simultaneously in a plurality of CCs.

If AP PowerClass is zero in all of the plurality of CCs for CA/DC, high power CA/DC UL transmission may be possible. In this case, coverage improvement in CA/DC operation is effective. If ΔP_PowerClass is not zero in any of the plurality of CCs for CA/DC, high power CA/DC UL transmission may not be possible. In this case, coverage improvement in CA/DC operation is not effective.

### <<Embodiment #1-2>>

The method for reporting the state information may follow at least one of the following reporting methods 1 to 3.

### [Reporting Method 1]

The state information may be included in a UCI on the PUCCH. The reporting may be periodic, semi-persistent, or aperiodic. The reporting may be periodic/semi-persistent in particular.

### [Reporting Method 2]

The state information may be included in a UCI on the PUSCH. The reporting may be periodic, semi-persistent, or aperiodic. The reporting may be periodic/semi-persistent in particular.

### [Reporting Method 3]

The state information may be included in a MAC CE on the PUSCH. The reporting may be periodic, semi-persistent, or aperiodic. The reporting may be periodic/semi-persistent in particular.

The MAC CE may be a new MAC CE or a part/reuse of an existing MAC CE. For example, the existing MAC CE may be a PHR MAC CE. If the PHR MAC CE is used to report the state information, the ΔP_PowerClass for the report may be used in the PHR calculation.

### [[Example 1]]

The existing MAC CE may be a single-entry PHR MAC CE.

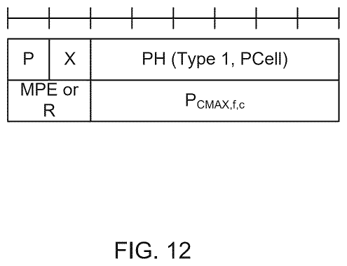

As shown in the example of FIG. 12, in the single-entry PHR MAC CE, the “R” field in the first octet may be replaced with a specific field (for example, “X” field). For example, the “X” field may indicate whether ΔP_PowerClass is zero or not.

### [[Example 2]]

The existing MAC CE may be a multiple-entry PHR MAC CE.

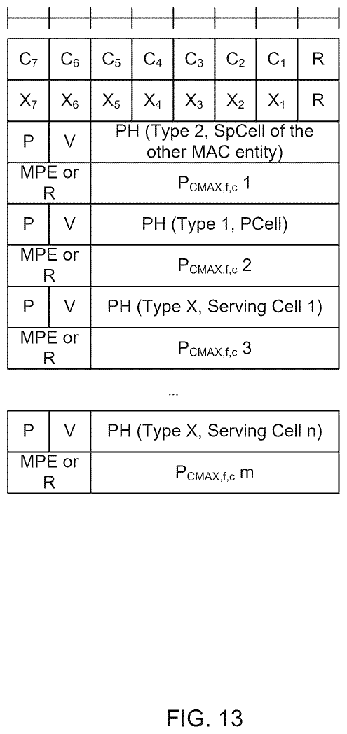

As shown in the example of FIG. 13, one or more new octets may be added to the multiple-entry PHR MAC CE. The new octets may include N specific fields (for example, “X_i” fields). For example, the “X_i” fields may indicate whether the ΔP_PowerClass corresponding to the index i of the activated cell is zero or not.

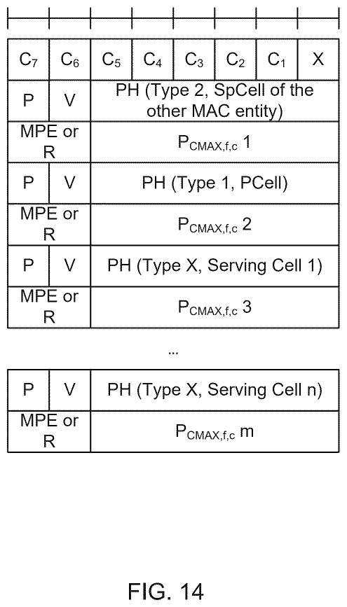

The multiple-entry PHR MAC CE may include one specific field. As shown in the example of FIG. 14, the “R” field in the first octet may be replaced with a specific field (for example, “X” field). For example, the “X” field may indicate whether all ΔP_PowerClasses are zero or not (at least one ΔP_PowerClass is not zero) for all activated cells.

### [[Example 3]]

The existing MAC CE may be an extended single-entry PHR MAC CE or an extended multiple-entry PHR MAC CE.

One or more of the “R” fields may be replaced with a specific field (for example, “X” field).

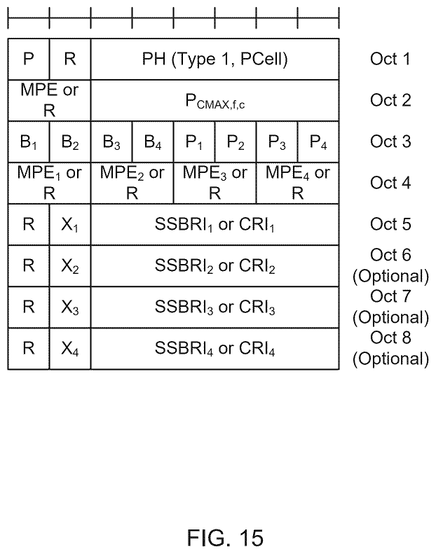

The existing MAC CE may include an “X_i” field for each beam (SSBRI or CRI). As shown in the example of FIG. 15, regarding “X i” field, the “R” field in the same octet as the SSBRI or CRI may be replaced with the “X_i” field. For example, the “X_i” field for each beam may indicate whether the ΔP_PowerClass corresponding to the beam is zero or not. By reporting the “X_i” field for each beam, the UE can determine/report beam-specific information, and the base station can use the beam-specific information for scheduling.

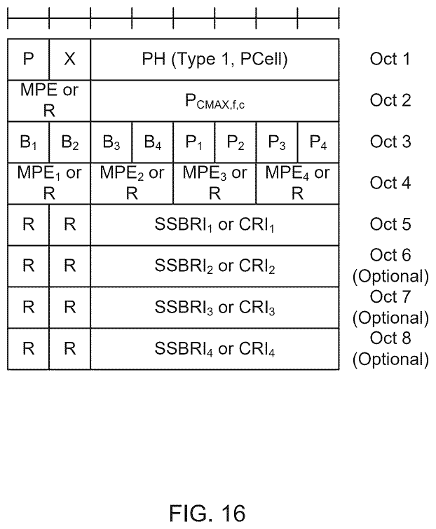

The existing MAC CE may include one “X” field. As shown in the example of FIG. 16, the “R” field in the first octet may be replaced with the “X” field. For example, the “X” field may indicate whether ΔP_PowerClass is zero or not (for all beams reported by this MAC CE).

The reporting of the state information may be configured by the RRC IE, may be triggered by the DL MAC CE, may be triggered by the DCI, or may be a combination of the configuration based on the RRC IE and the trigger based on the DL MAC CE/DCI.

### <<Embodiments #1-3>>

The state information may be reported at any of the following granularities:
[Granularity 1] The state information per CC/cell may be reported.
[Granularity 2] The state information for each activated cell may be reported.
[Granularity 3] Single state information may be reported for all activated cells.

### <<Embodiments #1-4>>

The number of pieces of state information per report may be any of the following:
[Number of piece of state information 1] One report may include only one piece of state information.
[Number of pieces of state information 2] One report may include a plurality of pieces of state information. For example, a report by the above-described reporting method 1 may include a plurality of pieces of state information corresponding to the plurality of cells.

According to these embodiments, the UE can utilize higher output power than the nominal maximum output power specified for the band/power class.

### <Supplementary Notes>

At least one operation of the above-described embodiments may be applied only to UEs that have reported or support a particular UE capability.

The specific UE capability may indicate at least one of the following:
Supporting the first embodiment.
Supporting the first embodiment for a certain band.
Supporting the first embodiment for a certain band combination.
Supporting the first embodiment for a certain band in a certain band combination.
Supporting the first embodiment for a certain CC in a certain band in a certain band combination.

The above-described specific UE capability may be a capability that is applied across all frequencies (in common regardless of frequency), or may be a capability for each frequency (for example, cell, band, BWP), or may be a capability for each frequency range (for example, Frequency Range 1 (FR1), FR2, FR3, FR4, FR5, FR2-1, or FR2-2), or may be a capability for each subcarrier spacing (SubCarrier Spacing (SCS)).

The specific UE capability may be a capability that is applied to all duplex modes (in common regardless of the duplex mode), or may be a capability for each duplex mode (for example, Time Division Duplex (TDD) or Frequency Division Duplex (FDD)),

At least one operation of the above-described embodiment may be applied when the UE is configured with specific information related to the above-described embodiments by higher layer signaling. For example, the specific information may be information indicating that at least one operation of the above-described embodiments is enabled, any RRC parameter for a specific release (for example, Rel. 18), or the like.

If the UE does not support at least one operation of the specific UE capability or is not configured with the above-described specific information, the UE may apply an operation of Rel. 15/16.17, for example.

### Supplementary Note

Regarding one embodiment of the present disclosure, the following supplementary notes of the invention will be given.

### {Supplementary Note 1}

A terminal including:
a transmitting section that transmits a report including one or more pieces of state information regarding utilization of higher output power than nominal maximum output power corresponding to a band; and
a control section that controls uplink transmission using the output power when the state information indicates that the utilization is possible.

### {Supplementary Note 2}

The terminal according to supplementary note 1, wherein each piece of the state information includes state information for each cell, or state information for each activated cell, or state information for all activated cells.

### {Supplementary Note 3}

The terminal according to supplementary note 1 or 2, wherein the state information indicates whether an adjustment to the nominal maximum output power is zero.

### {Supplementary Note 4}

The terminal according to any one of supplementary notes 1 to 3, wherein the report includes a power headroom report (PHR).

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

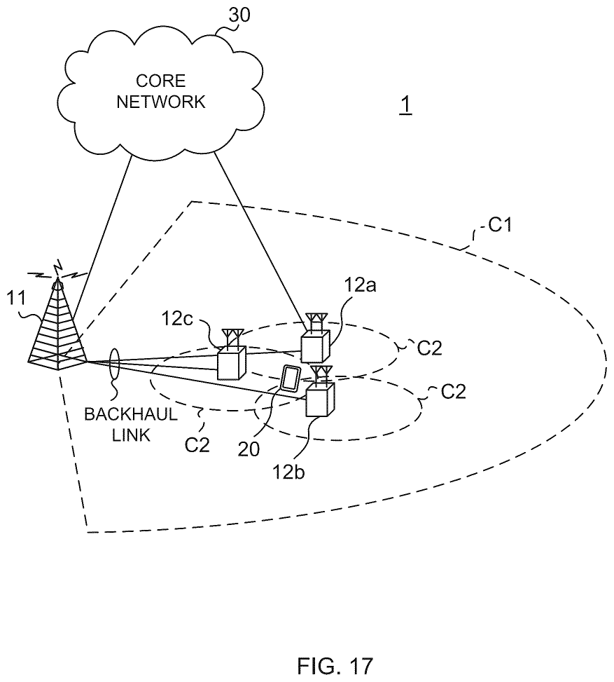

FIG. 17 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs), The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node,”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

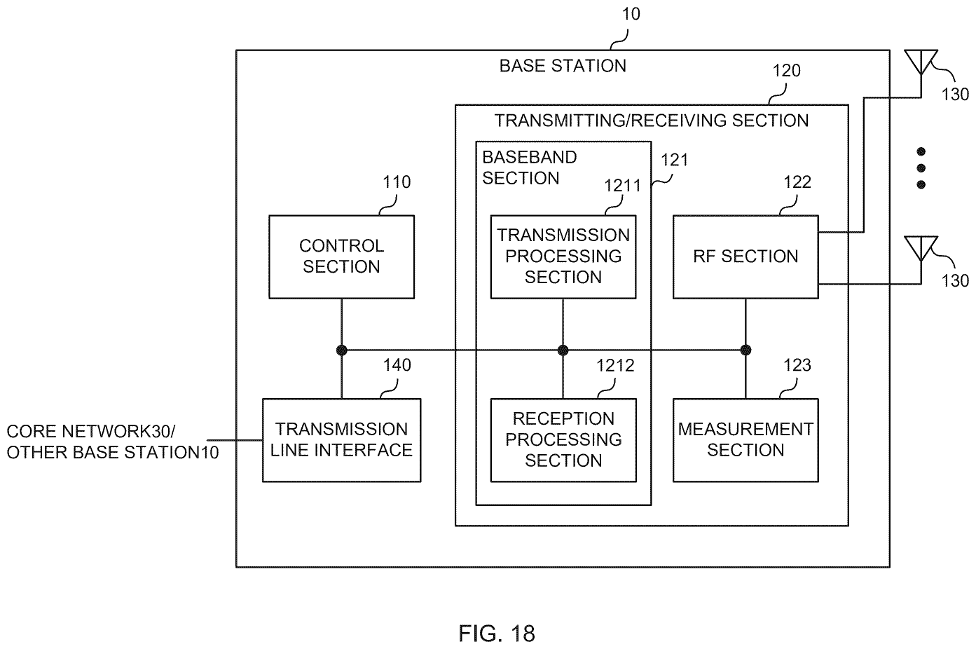

FIG. 18 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de mapping, demodulation, decoding (which may include error correction decoding), MAC layer processing, the processing of the RIC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140,

The transmitting/receiving section 120 may receive a report including one or more pieces of state information regarding utilization of higher output power than nominal maximum output power corresponding to a band.

The control section 110 may control uplink reception using the output power when the state information indicates that the utilization is possible.

### User Terminal

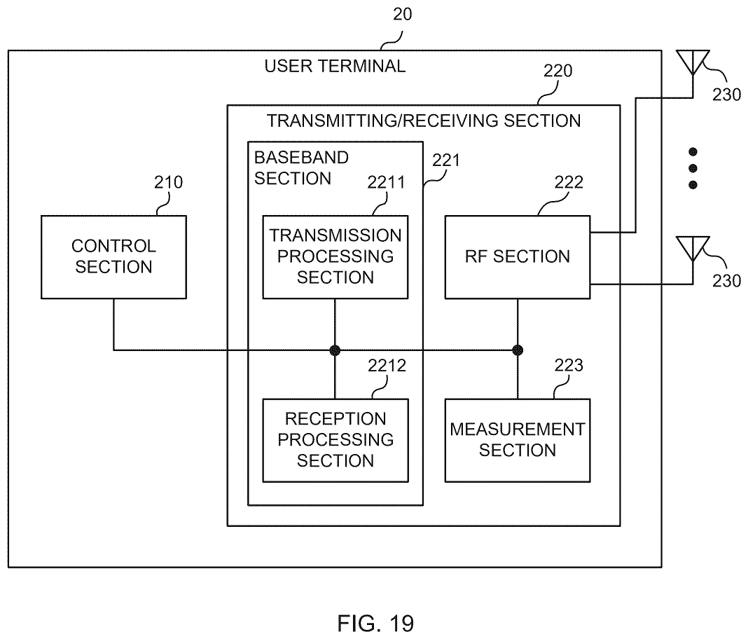

FIG. 19 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted,

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222, The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DET processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RE section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may transmit a report including one or more pieces of state information regarding utilization of higher output power than nominal maximum output power corresponding to a band. The control section 210 may control uplink transmission using the output power when the state information indicates that the utilization is possible.

Each piece of the state information may include state information for each cell, or state information for each activated cell, or state information for all activated cells.

The state information may indicate whether an adjustment to the nominal maximum output power is zero.

The report may include a power headroom report (PHR).

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

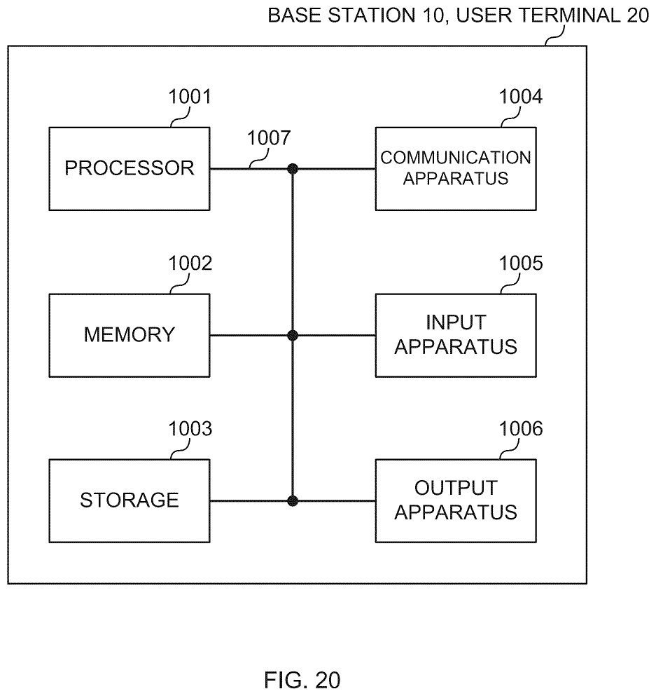

For example, a base station, a user terminal, and so on according to one embodiment of the present disclosure may function as a computer that executes the processes of the radio communication method of the present disclosure. FIG. 20 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on, For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on,

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots, Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on, Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TIIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB/RB group/set/pair,” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these,

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (ICI state),” a “spatial relation,” a “spatial domain filter,” “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the base station transmitting information to the terminal may be interchangeably interpreted as the base station indicating control/operation based on the information to the terminal.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases,

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor, and the like.

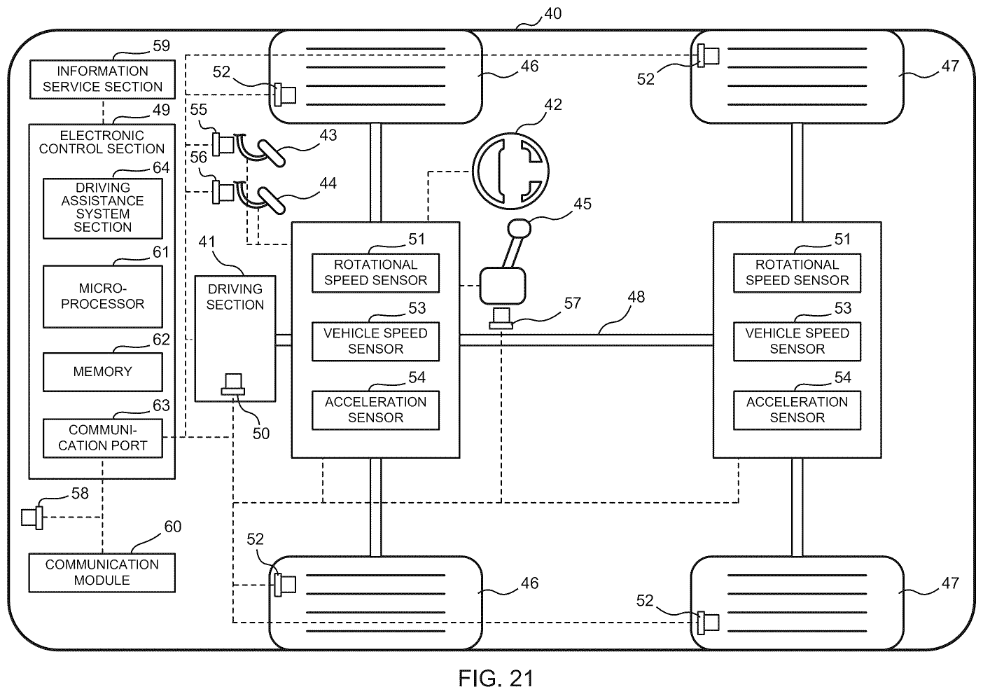

FIG. 21 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on,

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure, The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1-6. (canceled)

7. A terminal comprising:
a transmitter that transmits a report including information that indicates whether an adjustment to a maximum output power is zero; and
a processor that, when the information indicates that the adjustment is zero, controls to perform an uplink (UL) transmission that uses a higher output power than the maximum output power.

8. The terminal according to claim 7, wherein the report includes a power headroom report (PHR).

9. A radio communication method for a terminal, comprising:
transmitting a report including information that indicates whether an adjustment to a maximum output power is zero; and
when the information indicates that the adjustment is zero, controlling to perform an uplink (UL) transmission that uses a higher output power than the maximum output power.

10. A base station comprising:
a receiver that receives a report including information that indicates whether an adjustment to a maximum output power is zero; and
a processor that, when the information indicates that the adjustment is zero, controls to perform reception of an uplink (UL) transmission that uses a higher output power than the maximum output power.

11. A system comprising a terminal and a base station, wherein
the terminal comprises:
a transmitter that transmits a report including information that indicates whether an adjustment to a maximum output power is zero; and
a processor that, when the information indicates that the adjustment is zero, controls to perform an uplink (UL) transmission that uses a higher output power than the maximum output power, and the base station comprises:
a receiver that receives the report.
